(19) United States
(12) Patent Application Publication
(10) Pub. No.: US 2024/0289767 A1
(43) Pub. Date: Aug. 29, 2024

(54) SYSTEMS AND METHODS FOR PAYMENT TERMINAL ACCESSIBILITY USING MOBILE ELECTRONIC DEVICES

(71) Applicant: VeriFone, Inc., Wilmington, DE (US)

(72) Inventors: Michael Anthony Lucento, Alpharetta, GA (US); Bede Justin Dominick, Alpharetta, GA (US); Clinton Anthony Carey, Alpharetta, GA (US); Leon Jacob, Cumming, GA (US)

(73) Assignee: VeriFone, Inc., Wilmington, DE (US)

(21) Appl. No.: 18/566,132

(22) PCT Filed: Jun. 1, 2021
(86) PCT No.: PCT/US2021/035199

§ 371 Date: Dec. 1, 2023

(51) Int. Cl. G06Q 20/32

(52) U.S. Cl. CPC G06Q 20/326

(57) ABSTRACT

A method for payment terminal accessibility may include a payment terminal computer in a payment terminal: receiving, from a cloud services computer program, a request for a connection with a mobile device computer program, the payment terminal computer program executing a transaction flow comprising a plurality of portions, each portion associated with one or more transaction flow frames; communicating, to the mobile device computer program via the cloud services computer program, information for one of the transaction flow frames displayed the payment terminal, the transaction flow frame comprising text and a plurality of options for selection, the mobile device computer program configured to facilitate output of an accessible version of the transaction flow frame; receiving, a selection of one of the plurality of options from the mobile device computer program via the cloud services computer program; and executing, a next portion of the transaction flow based on the received selection.

### BACKGROUND OF THE INVENTION

### 1. Field of the Invention

The present disclosure relates generally to systems and methods for payment terminal accessibility using mobile electronic devices.

### 2. Description of the Related Art

Individuals with vision impairments sometimes have difficulty interacting with certain payment terminals without assistance from another person, such as a cashier or a store associate. Because the implementation of a transaction flow, such as a payment flow, may be different at each payment terminal, vision-impaired individuals may not be able to guess which step of transaction flow is currently displayed on the payment terminal.

### SUMMARY OF THE INVENTION

Systems and methods for payment terminal accessibility using mobile electronic devices are disclosed. In one embodiment, a method for payment terminal accessibility using a mobile electronic device may include: (1) receiving, by a payment terminal computer program executed by a computer processor in a payment terminal and from a cloud services computer program, a request for a connection with a mobile device computer program, the payment terminal computer program executing a transaction flow comprising a plurality of portions, each portion of the transaction flow associated with one or more transaction flow frames; (2) communicating, by the payment terminal computer program and to the mobile device computer program via the cloud services computer program, information for one of the transaction flow frames displayed on a display of the payment terminal, the transaction flow frame comprising text and a plurality of options for selection, wherein the mobile device computer program is configured to facilitate output of an accessible version of the transaction flow frame; (3) receiving, by the payment terminal computer program, a selection of one of the plurality of options from the mobile device computer program via the cloud services computer program; and (4) executing, by the payment terminal computer program, a next portion of the transaction flow based on the received selection.

In one embodiment, the request for a connection may include a session identifier, wherein the cloud services computer program may be configured to route communications between the mobile device computer program and the payment terminal computer program based on the session identifier.

In one embodiment, each transaction flow frame may have a frame identifier associated therewith, and the information for one of the transaction flow frames may include the frame identifier for the transaction flow frame that is displayed.

In one embodiment, the information for one of the transaction flow frames may include text of the transaction flow frame that is displayed.

In one embodiment, the method may further include communicating, by the payment terminal computer program and to the mobile device computer program via the cloud services computer program, information for a second transaction flow frame that is displayed on the display of the payment terminal, wherein the second transaction flow frame is associated with the next portion of the transaction flow.

In one embodiment, the transaction flow may include a purchase transaction or a menu-based interaction.

In one embodiment, the payment terminal may be a kiosk.

According to another embodiment, a mobile electronic device may include a memory a mobile electronic device computer program, an accessibility computer program, and a plurality of transaction flow frame for a transaction flow executed by a payment terminal computer program, wherein each transaction flow frame may be associated with a frame identifier; a display comprising a touch-sensitive user interface and an audio output. The mobile electronic device computer program may be configured to: request a session with a payment terminal computer program by communicating an identifier for a payment terminal executing the payment terminal computer program to a cloud services computer program; receive one of the frame identifiers from cloud services computer program for one of the transaction flow frames displayed on a display of the payment terminal; retrieve the transaction flow frame associated with the frame identifier from the plurality of transaction flow frames, wherein the transaction flow frame may include text and a plurality of options for selection; request an accessible version of the transaction flow frame from the accessibility computer program; receive the accessible version of the transaction flow frame from the accessibility computer program, wherein the accessible version of transaction flow frame may include audio of the text and a graphic for each of the plurality of options for selection; output the audio of the text using the audio output and output the graphics for the plurality of options for selection on the display; receive a selection of one of the graphics from the touch-sensitive user interface; and communicate a selection of the option associated with the graphic to the payment terminal computer program via the cloud services computer program.

In one embodiment, wherein the mobile electronic device computer program may be further configured to receive a session identifier from the cloud services computer program, wherein the cloud services computer program may be configured to route communications between the mobile electronic device computer program and the payment terminal computer program based on the session identifier.

In one embodiment, the mobile electronic device may include an image capture device, and the mobile electronic device computer program may be further configured to capture a machine-readable label comprising the identifier for the payment terminal executing the payment terminal computer program. The audio output may include a speaker, a Bluetooth audio output, etc.

In one embodiment, the transaction flow may include a purchase transaction, a menu-based interaction, etc.

According to another embodiment, a method for payment terminal accessibility using a mobile electronic device may include: (1) receiving, at a cloud services computer program, a request from a mobile device computer program to connect to a payment terminal computer program associated with a payment terminal identifier for a payment terminal, the payment terminal computer program executing a transaction flow; the transaction flow comprising a plurality of transaction flow frames; (2) communicating, by the cloud services computer program and to the payment terminal computer program, the request and a session identifier for a session between the mobile device computer program and the payment terminal computer program, wherein the cloud services computer program may be configured to route communications between the mobile device computer program and the payment terminal computer program based on the session identifier; (3) receiving, by the cloud services computer program and over a network from the payment terminal computer program, information for one of the transaction flow frames that is displayed on a display of the payment terminal, the transaction flow frame comprising text and a plurality of options for selection; (4) communicating, by the cloud services computer program and to the mobile device computer program, the information, wherein the mobile device computer program may be configured to output an accessible version of the transaction flow frame based on the information; (5) receiving, by the cloud services computer program and from the mobile device computer program, a selection of one of the plurality of options; and (6) communicating, by the cloud services computer program and to the payment terminal computer program, the selection, wherein the payment terminal computer program executes a next portion of the transaction flow based on the received selection.

In one embodiment, each transaction flow frame has a frame identifier associated therewith, and the information may include the frame identifier for the transaction flow frame that is displayed.

In one embodiment, the information for one of the transaction flow frames may include text of the transaction flow frame that is displayed.

In one embodiment, the transaction flow may include a purchase transaction, a menu-based interaction, etc.

In one embodiment, the payment terminal may be a kiosk.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 depicts a system for payment terminal accessibility using mobile electronic devices according to one embodiment;

FIGS. 2A and 2B depict a method for payment terminal accessibility using mobile electronic devices according to one embodiment;

FIG. 3 depicts a method for payment terminal accessibility using mobile electronic devices according to another embodiment; and

FIG. 4 depicts a method for payment terminal accessibility using mobile electronic devices according to another embodiment.

### DETAILED DESCRIPTION OF PREFERRED EMBODIMENTS

Embodiments are directed to systems and methods for payment terminal accessibility using mobile electronic devices.

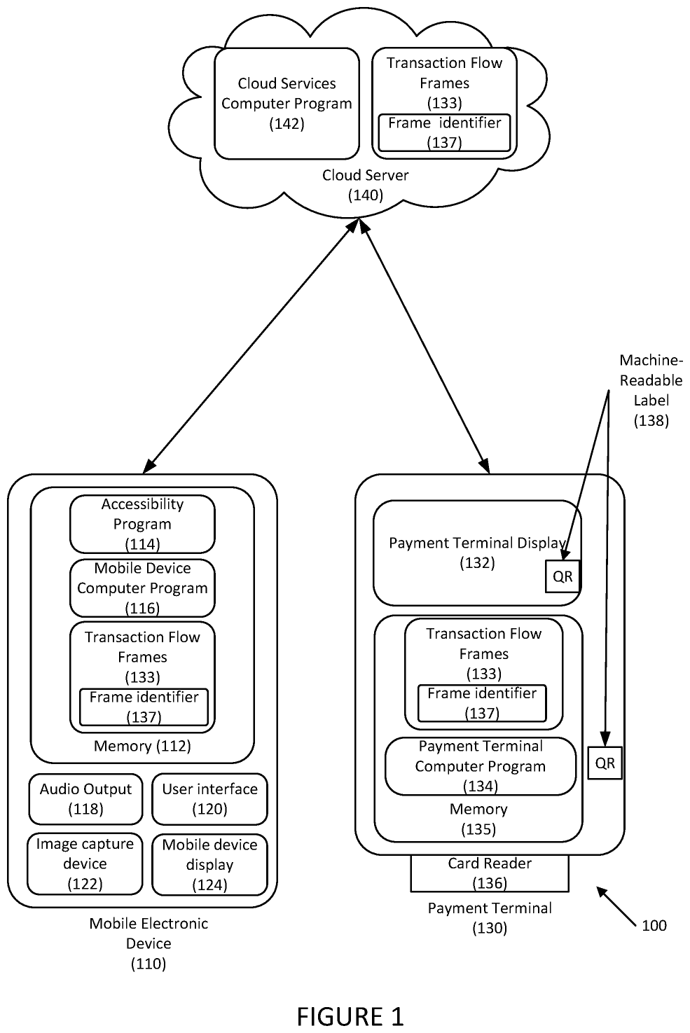

Referring to FIG. 1, a block diagram of a system for payment terminal accessibility using mobile electronic devices is disclosed according to one embodiment. System 100 may include mobile electronic device 110, payment terminal 130, and cloud server 140. Payment terminal 130 may be a point of sale device, a kiosk, an automated teller machine, etc. Mobile electronic device 110 may be a smart phone, a smart watch, a tablet computer, etc. Any suitable mobile electronic device may be used as is necessary and/or desired. Cloud server 140 may provide an interface between mobile electronic device 110 and payment terminal 130 using, for example, wired and/or wireless communication. Cloud server 140 may include one or more cloud-based processors (not shown), one or more databases (not shown), etc.

Mobile electronic device 110 may include memory 112 that may store accessibility program 114, mobile device computer program 116, and transaction flow frames 133. The mobile electronic device 110 may further include audio output 118 (e.g., a speaker, a headphone interface, a Bluetooth audio connection, etc.), user interface 120, such as a touch-sensitive screen, and image capture device 122 (e.g., a camera). Accessibility program 114 may provide accessibility features (e.g., voice-over functionality, text-to-speech functionality, color filters, magnifier, braille display, etc.). In one embodiment, accessibility program 114 may be part of the operating system for mobile electronic device 110, or it may be a separate program.

Mobile device computer program 116 may be an application provided by the operator of the payment terminal 130, such as a merchant, a third party, etc. In one embodiment, mobile device computer program 116 may access transaction flow frames 133 for a transaction flow executed by payment terminal computer program 134. In another embodiment, mobile device computer program 116 may download transaction flow frames 133 from, for example, cloud server 140 and/or payment terminal 130. In still another embodiment, mobile device computer program 116 may receive transaction flow frames 133 from payment terminal 130 via cloud services computer program 142 in real time.

The transaction flow executed by payment terminal computer program 134 may include a plurality of options for the customer to select from. Examples of transaction flows include a purchase transaction (e.g., payment at a payment terminal), a menu selection (e.g., food selection from a restaurant kiosk), a check-in transaction (e.g., check-in at an airline kiosk), a banking transaction (e.g., a withdrawal at an automated teller machine), etc. Each portion of the transaction flow may have one or more transaction flow frame 133 associated with it, and each transaction flow frame 133 may include text, graphics, and options for selection. For example, a first transaction flow frame 133 may be associated with a portion of the transaction flow where the customer provides data for items intended for purchase. A second transaction flow frame 133 may be associated with a portion of the transaction flow where the customer is prompted to select a method of payment. A third transaction flow frame 133 may be associated with a portion of the transaction flow where the customer is presented with confirmation of payment. The content of the transaction flow frames 133 generally depends on the portion of the transaction flow. Transaction flow frames 133 may be provided by the operator of the payment terminal 130, and may be duplicated, in whole or in part, and stored in memory 135 of payment terminal 130, in memory 112 of mobile electronic device 110, and in cloud server 140.

Each transaction flow frame 133 may be uniquely identified by frame identifier 137, and mobile device computer program 116 may retrieve the appropriate transaction flow frame 133 in response to receiving frame identifier 137 from payment terminal computer program 134. In some embodiments, the mobile device computer program 116 may retrieve the appropriate transaction flow frame 133 identified by the frame identifier 137 from cloud services computer program 142. In another embodiment, instead of receiving frame identifier 137 from payment terminal computer program 134, mobile device computer program 116 may receive the text and other components included within the respective transaction flow frame 133 displayed on payment terminal display 132 of payment terminal 130 via cloud services computer program 142.

Mobile device computer program 116 may provide the transaction flow frame 133 or the received text and other components of the transaction flow frame 133 displayed on payment terminal display 132 to the accessibility program 114. Accessibility program 114 may output, in an accessible manner, the contents of the transaction flow frame 133 or the received text and other components of transaction flow frame 133 displayed on payment terminal display 132 using audio output and/or using text or graphics on mobile device display 124.

Payment terminal 130 may include payment terminal display 132 and memory 135. Memory 135 may store transaction flow frames 133, each with a frame identifier, and payment terminal computer program 134. The content for transaction flow frames 133, like the text and other components, may be provided by the merchant operating payment terminal 130, the manufacturer of payment terminal 130, and/or other proprietor of payment terminal 130. In some embodiments, payment terminal 130 may include card reader 136. In one embodiment, payment terminal display 132 may display machine-readable label 138, such as a QR label, that may identify payment terminal 130 and may include an identifier for a network location (e.g., an IP address) for cloud services computer program 142. Machine-readable label 138 may be dynamic, and may change with each transaction, periodically, etc.; in another embodiment, machine-readable label 138 may be static. In another embodiment, machine-readable label 138 may be printed and affixed to a housing for payment terminal 130. Alternatively and/or additionally, the machine-readable label 138 may be provided via a contactless interaction with the payment terminal 130 upon request by another device, like for example, the mobile electronic device 110.

Payment terminal computer program 134 may control the transaction flow. Based on the transaction flow frame 133 displayed on payment terminal display 132, payment terminal computer program 134 may communicate frame identifier 137 for the transaction flow frame 133 displayed to mobile device computer program 116 via cloud services computer program 142 so that payment terminal computer program 134 and mobile device computer program 116 are substantially synchronized. In another embodiment, payment terminal computer program 134 may communicate the text of the transaction flow frame 133 displayed on payment terminal display 132 to cloud services computer program 142, which may provide the text to mobile device computer program 116.

Card reader 136 may be a contactless reader, such as an NFC reader, a chip (e.g., EMV chip) reader, a magnetic stripe reader, etc.

Cloud server 140 may provide an interface between mobile electronic device 110 and payment terminal 130. Cloud server 140 may be in wired and/or wireless communication with mobile electronic device 110 and payment terminal 130. Cloud server 140 may include one or more processors (not shown), one or more database (not shown), etc. Cloud server 140 may execute cloud services computer program 142 that may receive and send communications from and to mobile device computer program 116 and payment terminal computer program 134.

In one embodiment, cloud services computer program 142 may receive a request for a session with payment terminal computer program 134 from mobile device computer program 116. In response, cloud services computer program 142 may generate a unique session identifier for the session. For example, cloud services computer program 142 may receive an identifier for payment terminal 130 from mobile device computer program 116 and may identify payment terminal computer program 134 based on the identifier for payment terminal 130. Cloud services computer program 142 may associate mobile device computer program 116 and payment terminal computer program 134 with the session identifier, and may use the session identifier to route communications between mobile device computer program 116 and payment terminal computer program 134 while the session is valid (e.g., the transaction flow has not been completed).

In one embodiment, instead of using a session identifier, cloud services computer program 142 may maintain an association between payment terminal computer program 134 and mobile device computer program 116 during the transaction flow, and may route communications received from payment terminal computer program 134 to mobile device computer program 116, and vice-versa.

In one embodiment, cloud services computer program 142 may receive a communication from payment terminal computer program 134 that includes frame identifier 137 for transaction flow frame 133 displayed on payment terminal display 132. In another embodiment, cloud services computer program 142 may receive a communication from payment terminal computer program 134 that includes the text and any other components of transaction flow frame 133 that displayed on payment terminal display 132. Based on the session identifier, cloud services computer program 142 may identify mobile device computer program 116 and provide the communication to mobile device computer program 116. Cloud services computer program 142 may also receive a communication from mobile device computer program 116, such as a selection of an option. Based on the session identifier, cloud services computer program 142 may identify payment terminal computer program 134 and may provide the communication to payment terminal computer program 134. Payment terminal computer program 134 may proceed with the transaction flow based on the communication.

Cloud server 140 may further store transaction flow frames 133 with frame identifiers 137 and may make them available for downloading by mobile device computer program 116.

In other embodiments, mobile electronic device 110 may interact directly with the payment terminal 130 with minimal interaction with the server 140, if any. For instance, the mobile electronic device 110 may interact directly with payment terminal 130 via Wifi, Bluetooth, UWB and/or other wireless protocols to obtain transaction flow frames 133 and/or the text and other components of transaction flow frames 133. In this example, cloud server 140 may not be needed to provide and facilitate communication between mobile electronic device 110 and payment terminal 130.

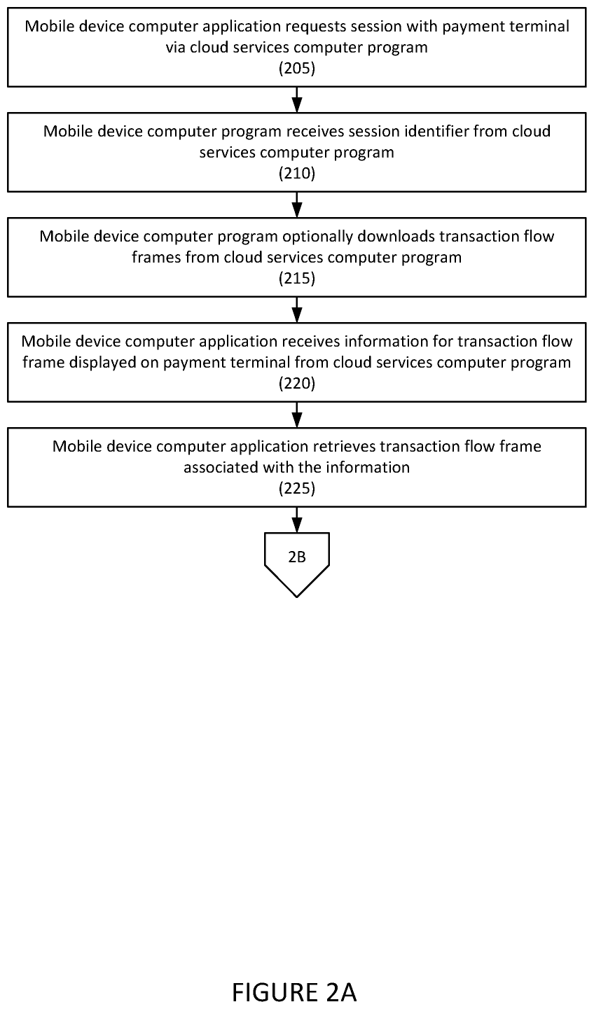

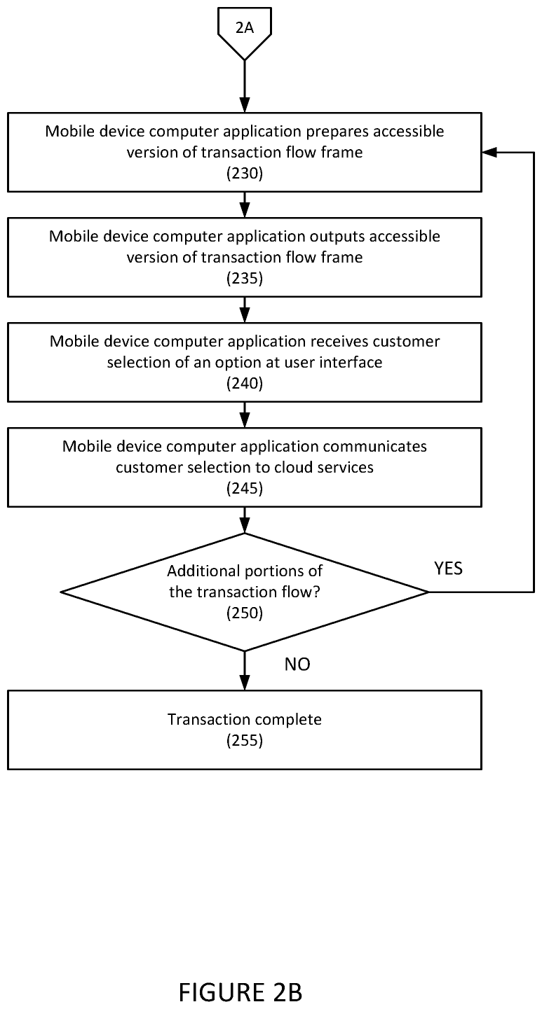

Referring to FIGS. 2A and 2B, a method for payment terminal accessibility using mobile electronic devices is disclosed according to an embodiment. FIGS. 2A and 2B describe a method for payment terminal accessibility from the perspective of a mobile electronic device 110 executing a mobile device computer program 116. The mobile device computer program 116 may be in wired and/or wireless communication with a cloud services computer program 142, and the cloud services computer program may be in wired and/or wireless communication with a payment terminal computer program 134.

In step 205, a mobile device computer program 116 executed by a mobile electronic device 110 may request a session identifier for a session with a payment terminal 130 via cloud services computer program 142. For example, the mobile device computer program 116 may control an image capture device, such as a camera, on the mobile electronic device 110 to scan or otherwise receive an identifier for the payment terminal 130 and a network location identified by a URL for the cloud services computer program 142 from, for example, a machine-readable label displayed by or on payment terminal 130. The mobile device computer program 116 may then access the network location identified by URL for the cloud services computer program 142 and provide the identifier the payment terminal 130. In another embodiment, the mobile device computer program 116 may request and/or receive the identifier using Bluetooth communication, NFC communication, etc. The mobile device computer program 116 may then provide the identifier to the cloud services computer program 142.

In step 210, the mobile device computer program 116 may receive a session identifier or similar from the cloud services computer program 142 that may be uniquely associated with the session between the mobile device computer program 116 and payment terminal 130. An example of a session identifier is a globally unique identifier, or GUID.

In step 215, the mobile device computer program 116 may optionally download transaction flow frames 133 with frame identifiers 137 for the transaction flow executed by payment terminal 130. In one embodiment, the mobile device computer program 116 may download transaction flow frames 133 from cloud services computer program 142, from an Internet location, etc. A complete set of transaction flow frames 133 may be downloaded before the transaction, or individual transaction flow frames 133 may be downloaded on demand, in real-time, as is necessary and/or desired.

In another embodiment, the mobile device computer program 116 may include (e.g., be programmed with) the some or all of the transaction flow frames 133. In one embodiment, each transaction flow frame 133 may be associated with a frame identifier 137, and the frame identifier 137 may be used by the mobile device computer program to retrieve the transaction flow frame 133 associated with the frame identifier 137.

In step 220, the mobile device computer program 116 may receive information for the transaction flow frame 133 displayed on the payment terminal display 132 from cloud services computer program 142. In one embodiment, the information may include a frame identifier 137 identifying the transaction flow frame 133 displayed on the payment terminal display 132. In another embodiment, the communication may include the text displayed on the payment terminal display 132, such as instructions, options for selection, etc. The information may further include the session identifier, which may be used by the cloud services computer program 142 to route communications between the mobile device computer program 116 and the payment terminal computer program 134.

In step 225, the mobile device computer program 116 may retrieve the transaction flow frame 133 based on the information. For example, if a frame identifier 137 for the transaction flow frame 133 is provided, the mobile device computer program 116 may retrieve the transaction flow frame 133 associated with the frame identifier 137.

In another embodiment, if the mobile device computer program 116 received the text of the transaction flow frame 133 that displayed on the payment terminal display 132 of payment terminal 130, it may not be necessary to retrieve a transaction flow frame 133.

In step 230, the mobile device computer program 116 may prepare an accessible version of the transaction flow frame 133 or the received text. For example, the mobile device computer program 116 may interface with an accessibility program 114, such as an accessibility program that is part of the operating system for the mobile electronic device and may receive the accessible version of the transaction flow frame 133 or the received text from accessibility program 114. In one embodiment, the accessible version of the transaction flow frame 133 or the received text may include audio of the text of the payment terminal display information, graphical buttons for options, etc. The graphical buttons may include high contrast lettering, large size fonts, etc.

In one embodiment, the audio may include identifiers for the different options in the transaction flow frame 133 that may be associated with the graphical buttons. For example, the accessible version may instruct the customer to “Press 1 for $20 cash back, press 2 for $40 cash back, or press 3 to cancel.” The mobile device computer program 116 may cause the screen to display the graphical buttons.

In one embodiment, the audio may identify touch-based gestures that may be associated with the options in the transaction flow frame 133, such as one tap for a first option, two taps for a second option, etc. Other touch-based gestures, such as a swipe direction, a duration of a touch (e.g., short touch, long touch, etc.) may be used as is necessary and/or desired.

In step 235, the accessible version of the transaction flow frame 133 or the received text may be output. In one embodiment, the mobile device computer program 116 may output the accessible version of the transaction flow frame 133. For example, the mobile device computer program 116 may receive the accessible version of the transaction flow frame 133 from the accessibility program 114 and may output it using user interface 120 and/or audio output 118. In another embodiment, the accessibility program 114 may output the accessible version of transaction flow frame 133.

In step 240, the mobile device computer program 116 may receive a customer selection of one of the options included in the accessible version of the transaction flow frame 133 at a user interface on the mobile device. For example, the mobile device computer program 116 may receive a selection of a graphical button on the screen, a gesture from the screen, a spoken selection from a microphone, etc. As necessary, the mobile device computer program 116 may convert the gesture or spoken selection to a selected option. For example, the mobile device computer program 116 may access accessibility program 114 or any other suitable program to convert the gesture or spoken selection to the selected option.

In step 245, the mobile device computer program 116 may communicate the selected option to cloud services computer program 142. In one embodiment, the mobile device computer program 116 may include the session identifier with the communication so the cloud services computer program 142 can route the selected option to the payment terminal computer program 134.

If, in step 250, there are additional portions of the transaction flow; the process may continue with step 230. If there are no additional portions of the transaction flow, in step 255, the transaction may be complete.

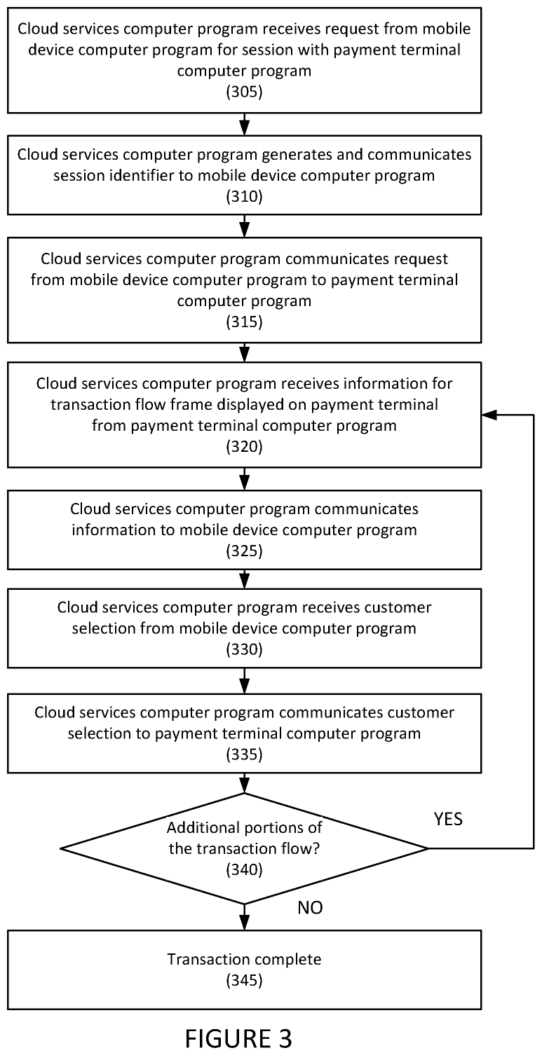

Referring to FIG. 3, a method for payment terminal accessibility using mobile electronic devices is disclosed according to another embodiment. FIG. 3 describes a method for payment terminal accessibility from the perspective of a cloud services computer program 142. The cloud services computer program 142 may be in wired and/or wireless communication with a mobile device computer program 116 and a payment terminal computer program 134.

In step 305, a cloud services computer program 142 may receive a request for a session from the mobile device computer program 116 to the payment terminal computer program 134. In one embodiment, the request for a connection may be received at a network location defined by a URL for the cloud services computer program 142 and may include an identifier for payment terminal. In one embodiment, the request for a session may include an identifier for the payment terminal computer program 134.

In step 310, the cloud services computer program 142 may generate and communicate the session identifier to the mobile device computer program 116. An example of a session identifier is a globally unique identifier, or GUID. The cloud services computer program 142 may identify the payment terminal computer program 134 associated with the received identifier using, for example, a database lookup. In one embodiment, the cloud services computer program 142 may associate the mobile device computer program 116 and payment terminal computer program 134 with the session identifier, and may use the session identifier to route communications between the mobile device computer program 116 and the payment terminal computer program 134 while the session is valid.

In step 315, the cloud services computer program 142 may communicate the request to the payment terminal computer program 134 for the payment terminal 130 associated with the identifier. In one embodiment, the cloud services computer program 142 may include the session identifier in the communication.

In step 320 the cloud services computer program 142 may receive information for the transaction flow frame 133 that is displayed on a payment terminal display 132 of the payment terminal from the payment terminal computer program 134. In one embodiment, the communication may include a frame identifier 137 that identifies the transaction flow frame 133 displayed on the payment terminal display 132. In another embodiment, the communication may include the text of the transaction flow frame 133 that is displayed on the payment terminal display 132, such as instructions, options for selection, etc. The communication may further include the session identifier.

In step 325, the cloud services computer program 142 may communicate the information to the mobile device computer program 116. In one embodiment, the cloud services computer program 142 may use the session identifier to identify the cloud services computer program 142 as the destination for the information before communicating the payment terminal display information to the mobile device computer program 116.

In step 330, the cloud services computer program 142 may receive a communication with a customer selection from the mobile device computer program 116. In one embodiment, the communication may include the session identifier, and, in step 335, the cloud services computer program 142 may use the session identifier to identify the payment terminal computer program 134 and may then route the communication to the payment terminal computer program 134

If, in step 340, there are additional portions of the transaction flow, the process may continue with step 315. If there are no additional portions of the transaction flow, in step 345, the transaction may be complete, and the cloud services computer program 142 may terminate the session. In one embodiment, the cloud services computer program 142 may add the session identifier to a prohibited list of used session identifiers.

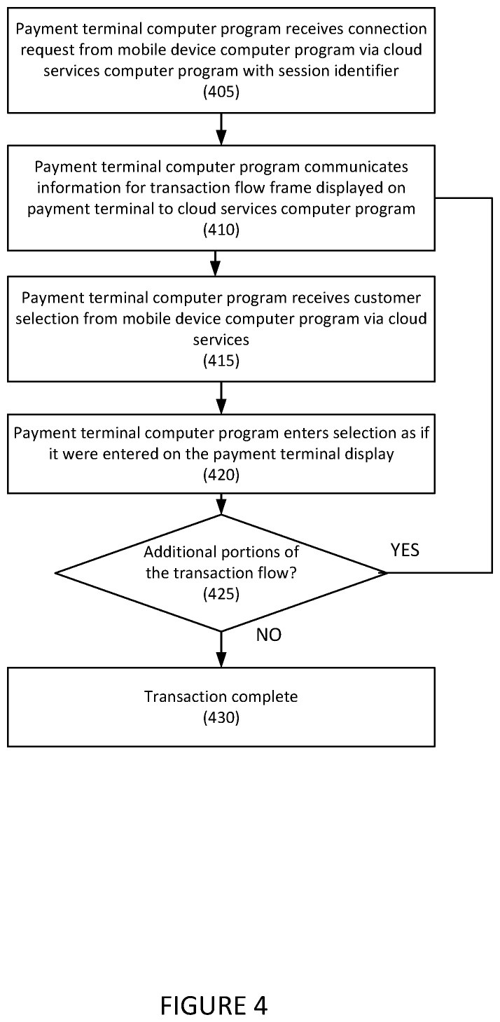

Referring to FIG. 4, a method for payment terminal accessibility using mobile electronic devices is disclosed according to another embodiment. FIG. 4 describes a method for payment terminal accessibility from the perspective of a payment terminal 130 executing payment terminal computer program 134. The payment terminal computer program 134 may be in wired and/or wireless communication with a cloud services computer program 142, and the cloud services computer program may be in wired and/or wireless communication with a mobile device computer program 116.

In step 405, a payment terminal computer program 134 may receive a request for a session from a mobile device computer program 116 via cloud services computer program 142. In one embodiment, the connection request may include a session identifier or similar that may be generated by the cloud services program. An example of a session identifier is a globally unique identifier, or GUID.

In step 410, the payment terminal computer program 134 may communicate information for the transaction flow frame 133 that is displayed on a display of the payment terminal to cloud services computer program 142. In one embodiment, the information may include a frame identifier 137 identifying the transaction flow frame 133 displayed on the payment terminal display 132. In another embodiment, the communication may include the text of the transaction flow frame 133 that is displayed on the payment terminal display 132, such as instructions, options for selection, etc. The information may further include the session identifier.

In step 415, the payment terminal computer program 134 may receive a customer selection of one of the options from the mobile device computer program 116 via cloud services computer program 142. In one embodiment, the communication may include the session identifier.

In one embodiment, the payment terminal computer program 134 may validate that the session identifier received from cloud services computer program 142 is the same as the session identifier received in step 405.

In step 420, the payment terminal computer program 134 may enter the selection as if it were entered on the payment terminal display. This may result in the display of another transaction flow frame 133 for the next portion of the transaction flow, the completion of a transaction, the display of a confirmation message, etc.

If, in step 425, there are additional portions of the transaction flow, the process may continue with step 410. If there are no additional portions of the transaction flow, in step 430, the transaction may be complete.

It will be appreciated by persons skilled in the art that the present invention is not limited by what has been particularly shown and described hereinabove. Rather, the scope of the present invention includes both combinations and sub-combinations of features described hereinabove and variations and modifications thereof, which are not in the prior art. It should further be recognized that these embodiments are not exclusive to each other.

It will be readily understood by those persons skilled in the art that the embodiments disclosed herein, are susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for payment terminal accessibility using a mobile electronic device, comprising:
receiving, by a payment terminal computer program executed by a computer processor in a payment terminal and from a cloud services computer program, a request for a connection with a mobile device computer program, the payment terminal computer program executing a transaction flow comprising a plurality of portions, each portion of the transaction flow associated with one or more transaction flow frames;
communicating, by the payment terminal computer program and to the mobile device computer program via the cloud services computer program, information for one of the transaction flow frames displayed on a display of the payment terminal, the transaction flow frame comprising text and a plurality of options for selection, wherein the mobile device computer program is configured to facilitate output of an accessible version of the transaction flow frame;
receiving, by the payment terminal computer program, a selection of one of the plurality of options from the mobile device computer program via the cloud services computer program; and
executing, by the payment terminal computer program, a next portion of the transaction flow based on the received selection.

2. The method of claim 1, wherein the request for a connection comprises a session identifier, wherein the cloud services computer program is configured to route communications between the mobile device computer program and the payment terminal computer program based on the session identifier.

3. The method of claim 1, wherein each transaction flow frame has a frame identifier associated therewith, and the information for one of the transaction flow frames comprises the frame identifier for the transaction flow frame that is displayed.

4. The method of claim 1, wherein the information for one of the transaction flow frames comprises text of the transaction flow frame that is displayed.

5. The method of claim 1, further comprising:
communicating, by the payment terminal computer program and to the mobile device computer program via the cloud services computer program, information for a second transaction flow frame that is displayed on the display of the payment terminal, wherein the second transaction flow frame is associated with the next portion of the transaction flow.

6. The method of claim 1, wherein the transaction flow comprises a purchase transaction or a menu-based interaction.

7. The method of claim 1, wherein the payment terminal comprises a kiosk.

8. A mobile electronic device comprising:
a memory comprising:
a mobile electronic device computer program;
an accessibility computer program; and
a plurality of transaction flow frame for a transaction flow executed by a payment terminal computer program, wherein each transaction flow frame is associated with a frame identifier;
a display comprising a touch-sensitive user interface; and
an audio output;
wherein the mobile electronic device computer program is configured to:
request a session with a payment terminal computer program by communicating an identifier for a payment terminal executing the payment terminal computer program to a cloud services computer program;
receive one of the frame identifiers from cloud services computer program for one of the transaction flow frames displayed on a display of the payment terminal;
retrieve the transaction flow frame associated with the frame identifier from the plurality of transaction flow frames, wherein the transaction flow frame comprises text and a plurality of options for selection;
request an accessible version of the transaction flow frame from the accessibility computer program;
receive the accessible version of the transaction flow frame from the accessibility computer program, wherein the accessible version of transaction flow frame comprises audio of the text and a graphic for each of the plurality of options for selection;
output the audio of the text using the audio output and output the graphics for the plurality of options for selection on the display;
receive a selection of one of the graphics from the touch-sensitive user interface; and
communicate a selection of the option associated with the graphic to the payment terminal computer program via the cloud services computer program.

9. The mobile electronic device of claim 8, wherein the mobile electronic device computer program is further configured to receive a session identifier from the cloud services computer program, wherein the cloud services computer program is configured to route communications between the mobile electronic device computer program and the payment terminal computer program based on the session identifier.

10. The mobile electronic device of claim 8, further comprising an image capture device, wherein the mobile electronic device computer program is further configured to capture a machine-readable label comprising the identifier for the payment terminal executing the payment terminal computer program.

11. The mobile electronic device of claim 8, wherein the audio output comprises a speaker.

12. The mobile electronic device of claim 8, wherein the audio output comprises a Bluetooth audio output.

13. The mobile electronic device of claim 8, wherein the transaction flow comprises a purchase transaction.

14. The mobile electronic device of claim 8, wherein the transaction flow comprises a menu-based interaction.

15. A method for payment terminal accessibility using a mobile electronic device, comprising:
receiving, at a cloud services computer program, a request from a mobile device computer program to connect to a payment terminal computer program associated with a payment terminal identifier for a payment terminal, the payment terminal computer program executing a transaction flow, the transaction flow comprising a plurality of transaction flow frames;
communicating, by the cloud services computer program and to the payment terminal computer program, the request and a session identifier for a session between the mobile device computer program and the payment terminal computer program, wherein the cloud services computer program is configured to route communications between the mobile device computer program and the payment terminal computer program based on the session identifier;
receiving, by the cloud services computer program and over a network from the payment terminal computer program, information for one of the transaction flow frames that is displayed on a display of the payment terminal, the transaction flow frame comprising text and a plurality of options for selection;
communicating, by the cloud services computer program and to the mobile device computer program, the information, wherein the mobile device computer program is configured to output an accessible version of the transaction flow frame based on the information;
receiving, by the cloud services computer program and from the mobile device computer program, a selection of one of the plurality of options; and
communicating, by the cloud services computer program and to the payment terminal computer program, the selection, wherein the payment terminal computer program executes a next portion of the transaction flow based on the received selection.

16. The method of claim 15, wherein each transaction flow frame has a frame identifier associated therewith, and the information comprises the frame identifier for the transaction flow frame that is displayed.

17. The method of claim 15, wherein the information for one of the transaction flow frames comprises text of the transaction flow frame that is displayed.

18. The method of claim 15, wherein the transaction flow comprises a purchase transaction.

19. The method of claim 15, wherein the transaction flow comprises a menu-based interaction.

20. The method of claim 15, wherein the payment terminal comprises a kiosk.
